(19) United States
(12) Patent Application Publication
(10) Pub. No.: US 2024/0085256 A1
(43) Pub. Date: Mar. 14, 2024

(54) LOAD SENSOR

(71) Applicant: Panasonic Intellectual Property Management Co., Ltd., Osaka (JP)

(72) Inventors: Yodai MATSUMURA, Osaka (JP); Takashi MATSUMOTO, Osaka (JP); Susumu URAGAMI, Osaka (JP); Yuta MORIURA, Osaka (JP); Takafumi HAMANO, Osaka (JP); Hiroyuki FURUYA, Osaka (JP)

(21) Appl. No.: 18/508,167

(22) Filed: Nov. 13, 2023

Related U.S. Application Data
(63) Continuation of application No. PCT/JP2022/006588, filed on Feb. 18, 2022.

(30) Foreign Application Priority Data
May 14, 2021 (JP) 2021-082530

(51) Int. Cl. G01L 5/101; G01L 1/14

(52) U.S. Cl. CPC G01L 5/101; G01L 1/142

(57) ABSTRACT

A load sensor is configured to detect, as change in capacitance, change, in a contact area between an electrically-conductive elastic body and a dielectric body, that occurs due to a load applied to an upper face of the load sensor. In the load sensor, a plurality of sensor parts each configured to detect the load are disposed so as to be arranged in a plane direction, and a buffer part configured to suppress displacement of the upper face due to the load applied to a first sensor part from being propagated to a second sensor part adjacent to the first sensor part is disposed between the first sensor part and the second sensor part.

### CROSS REFERENCE TO RELATED APPLICATION

This application is a continuation of International Application No. PCT/JP2022/006588 filed on Feb. 18, 2022, entitled “LOAD SENSOR”, which claims priority under 35 U.S.C. Section 119 of Japanese Patent Application No. 2021-082530 filed on May 14, 2021, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2018/096901 describes a pressure-sensitive element including: a first electrically-conductive member made of a sheet-shaped electrically-conductive rubber; a second electrically-conductive member having a linear shape and sandwiched between the first electrically-conductive member and a base member; and a dielectric body formed so as to cover the second electrically-conductive member. For each region where the first electrically-conductive member and the second electrically-conductive member cross each other with the dielectric body therebetween, a load is detected. In this configuration, in association with increase in the load, the contact area between the first electrically-conductive member and the dielectric body increases, and in association therewith, capacitance between the first electrically-conductive member and the second electrically-conductive member increases. Therefore, by detecting the value of the capacitance between the first electrically-conductive member and the second electrically-conductive member, it is possible to detect the load applied to the pressure-sensitive element.

In the above configuration, the region where the first electrically-conductive member and the second electrically-conductive member cross each other with the dielectric body therebetween serves as a sensor part where the load is detected. In the above configuration, in general, the first electrically-conductive member is set on a sheet-shaped member, and a load is applied to the upper face of the sheet-shaped member. However, in this configuration, displacement of the upper face due to a load applied to the first sensor part is propagated to a second sensor part positioned adjacent to the first sensor part. Thus, even when a load is applied only to the first sensor part, false detection of a load in the second sensor part may occur.

### SUMMARY OF THE INVENTION

A major aspect of the present invention relates to a load sensor configured to detect, as change in capacitance, change, in a contact area between an electrically-conductive elastic body and a dielectric body, that occurs due to a load applied to an upper face of the load sensor. In the load sensor according to the present aspect, a plurality of sensor parts each configured to detect the load are disposed so as to be arranged in a plane direction, and a buffer part configured to suppress displacement of the upper face due to the load applied to a first sensor part from being propagated to a second sensor part adjacent to the first sensor part is disposed between the first sensor part and the second sensor part.

In the load sensor according to the present aspect, when a load has been applied only to the first sensor part, deformation, in accordance with deformation of the upper face in the first sensor part, of the upper face in the second sensor part is suppressed by the buffer part. Therefore, in this case, change in the contact area between the electrically-conductive elastic body and the dielectric body in the second sensor part is suppressed. Therefore, false detection of a load in the second sensor part can be suppressed.

The effects and the significance of the present invention will be further clarified by the description of the embodiments below. However, the embodiments below are merely examples for implementing the present invention. The present invention is not limited to the embodiments below in any way.

### BRIEF DESCRIPTION OF THE DRAWINGS

FIG. 1A is a perspective view schematically showing a sheet-shaped member on the lower side and electrically-conductive elastic bodies set on an opposing face of the sheet-shaped member on the lower side, according to Embodiment 1;

FIG. 1B is a perspective view schematically showing a state where conductor wires and threads are set on the structure in FIG. 1A, according to Embodiment 1;

FIG. 2A is a perspective view schematically showing a sheet-shaped member on the upper side disposed so as to be superposed on the upper side of the sheet-shaped member on the lower side, according to Embodiment 1;

FIG. 2B is a perspective view schematically showing a state where the electrically-conductive elastic bodies are disposed on an opposing face of the sheet-shaped member on the upper side, according to Embodiment 1;

FIG. 3 is a perspective view schematically showing a state where the structure in FIG. 2B is set on the structure in FIG. 1B, according to Embodiment 1;

FIG. 4A and FIG. 4B are each a perspective view schematically showing a configuration of a buffer part according to Embodiment 1;

FIG. 5A and FIG. 5B are each a cross-sectional view schematically showing a configuration of a sensor part according to Embodiment 1;

FIG. 6 is a plan view schematically showing a configuration of the inside of the load sensor according to Embodiment 1.

FIG. 7A and FIG. 7B each schematically show a configuration of a load sensor according to verification of Embodiment 1;

FIG. 8A is a simulation result showing a relationship between: the contact length between the conductor wire and the electrically-conductive elastic body; and the load applied by a presser, according to verification of Embodiment 1;

FIG. 8B is a simulation result showing a relationship between: the displacement amount of an end portion at the lower face of the electrically-conductive elastic body; and the load applied by the presser, according to verification of Embodiment 1;

FIG. 9A and FIG. 9B are each a perspective view schematically showing a configuration of a buffer part according to Modification 1 of Embodiment 1;

FIG. 10A and FIG. 10B are each a perspective view schematically showing a configuration of a buffer part according to Modification 2 of Embodiment 1;

FIG. 11A and FIG. 11B are each a perspective view schematically showing a configuration of a buffer part according to Modification 3 of Embodiment 1;

FIG. 12A and FIG. 12B are each a perspective view schematically showing a configuration of a buffer part according to Embodiment 2;

FIG. 13A and FIG. 13B are each a perspective view schematically showing a configuration of a buffer part according to Modification 1 of Embodiment 2; and

FIG. 14A and FIG. 14B are each a perspective view schematically showing a configuration of a buffer part according to Modification 2 of Embodiment 2.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensors in the embodiments below are each a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to a detection circuit, and the load sensor and the detection circuit form a load detection device. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

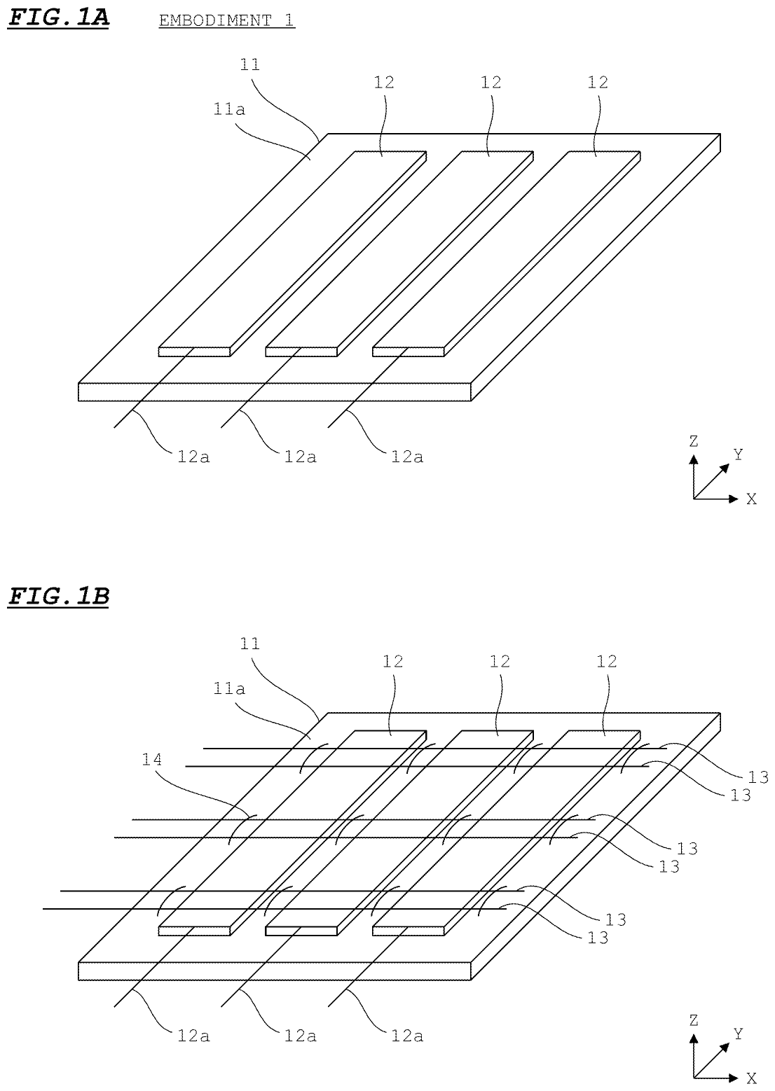

FIG. 1A is a perspective view schematically showing a sheet-shaped member 11 and electrically-conductive elastic bodies 12 set on an opposing face 11a (the face on the Z-axis positive side) of the sheet-shaped member 11.

The sheet-shaped member 11 is an insulative member having elasticity, and has a flat plate shape parallel to an X-Y plane. The thickness in the Z-axis direction of the sheet-shaped member 11 is 0.01 mm to 2 mm, for example.

The sheet-shaped member 11 is formed from a non-electrically-conductive resin material or a non-electrically-conductive rubber material. The resin material used in the sheet-shaped member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the sheet-shaped member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face 11a (the face on the Z-axis positive side) of the sheet-shaped member 11. In FIG. 1A, three electrically-conductive elastic bodies 12 are formed on the opposing face 11a of the sheet-shaped member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

Each electrically-conductive elastic body 12 is formed on the opposing face 11a of the sheet-shaped member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the sheet-shaped member 11.

Each electrically-conductive elastic body 12 is formed from a resin material and an electrically-conductive filler dispersed therein, or from a rubber material and an electrically-conductive filler dispersed therein.

Similar to the resin material used in the sheet-shaped member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the sheet-shaped member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 and threads 14 are disposed on the structure in FIG. 1A.

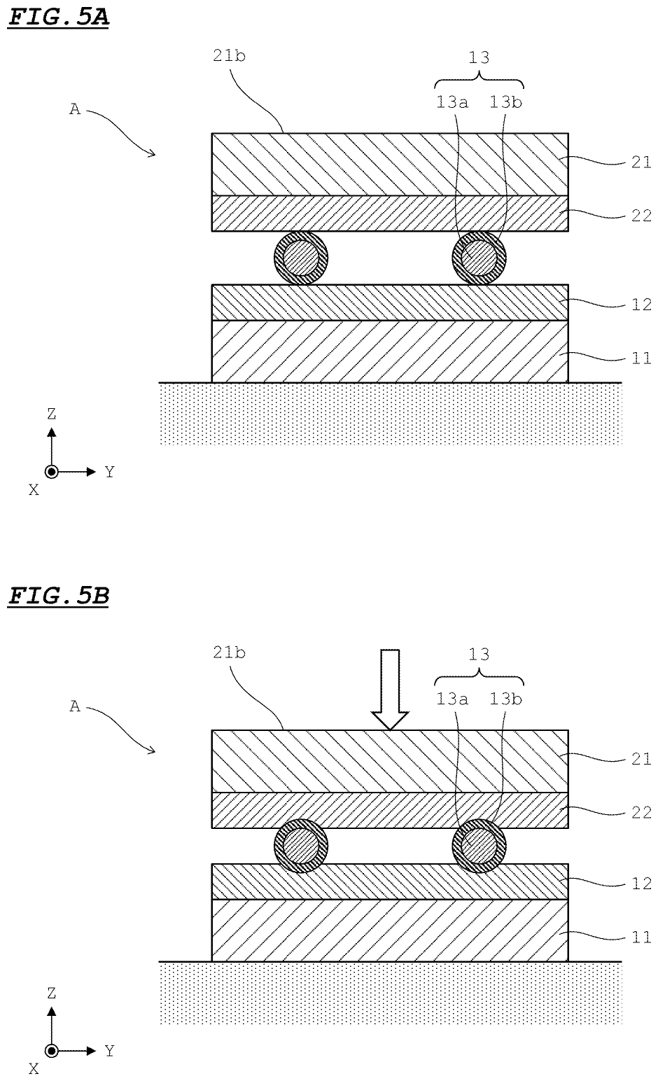

Each conductor wire 13 has a line shape and extends in the X-axis direction. The conductor wires 13 are disposed so as to be arranged in the Y-axis direction with a predetermined interval therebetween. In the example shown in FIG. 1B, six conductor wires 13 are disposed. Each conductor wire 13 is composed of: an electrically-conductive member having a linear shape; and a dielectric body formed on the surface of the electrically-conductive member. The configuration of the conductor wire 13 will be described later with reference to FIGS. 5A, 5B.

After a plurality of sets each composed of adjacent two conductor wires 13 have been disposed as in FIG. 1B, each set of the conductor wires 13 is set on the sheet-shaped member 11 by threads 14. In the example shown in FIG. 1B, twelve threads 14 connect the conductor wires 13 to the sheet-shaped member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like. Two conductor wires 13 included in one set are connected to each other in a wiring or a circuit in a subsequent stage.

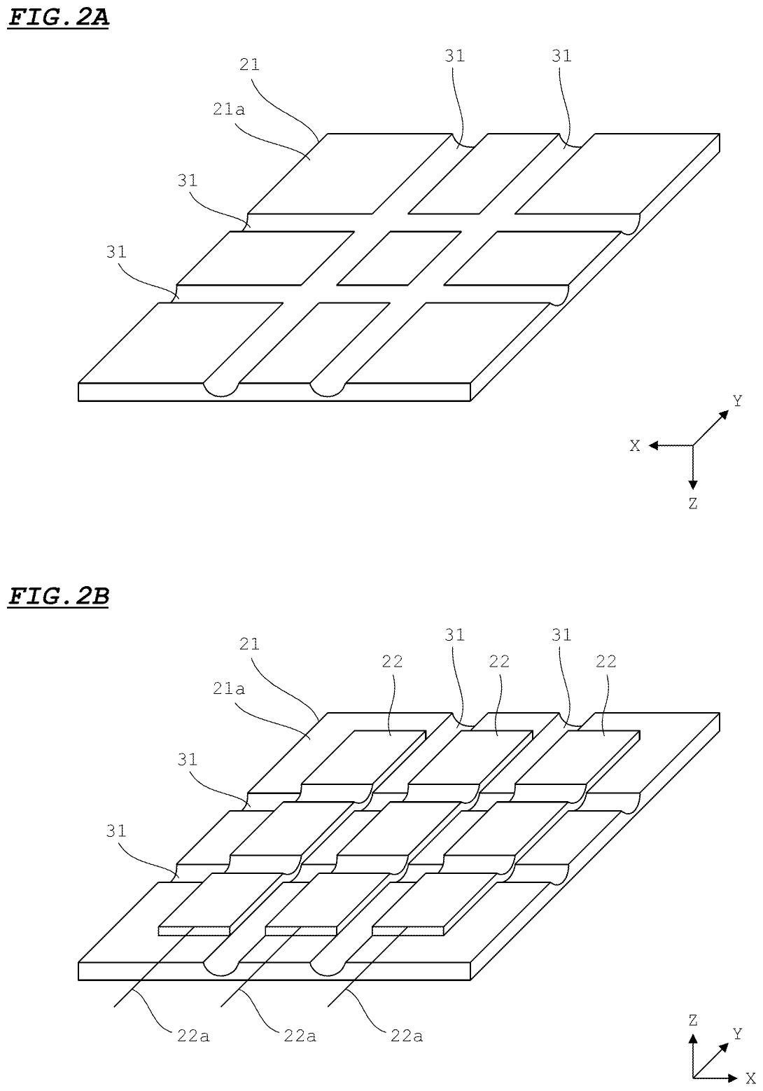

FIG. 2A is a perspective view schematically showing a sheet-shaped member 21 disposed so as to be superposed on the upper side of the sheet-shaped member 11.

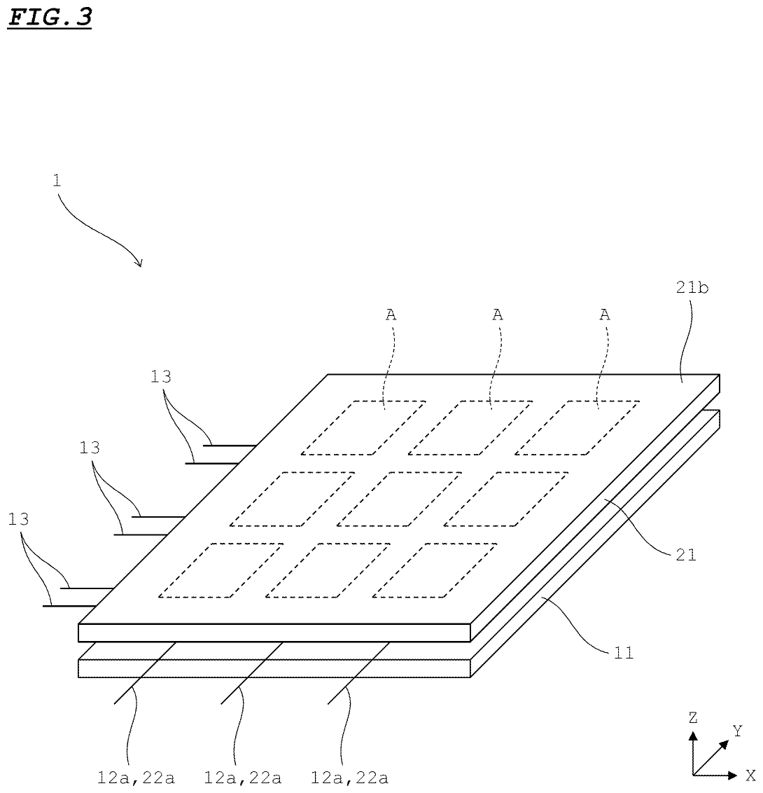

The sheet-shaped member 21 has, in a plan view, the same size and shape as those of the sheet-shaped member 11 and is formed from the same material as that of the sheet-shaped member 11. The thickness in the Z-axis direction of the sheet-shaped member 21 is 0.01 mm to 2 mm, for example. In an opposing face 21a (the face on the Z-axis negative side) of the sheet-shaped member 21, grooves 31 extending in the X-axis direction and the Y-axis direction and each having a cylindrical surface shape (whose cross section has an arc shape) are formed. The grooves 31 are provided so as to demarcate sensor parts A described later with reference to FIG. 3. In the example shown in FIG. 2A, two grooves 31 extending in the X-axis direction are provided, and two grooves 31 extending in the Y-axis direction are provided. Each groove 31 is formed by cutting off portions on the face on the Z-axis negative side of a material having a flat plate shape.

FIG. 2B is a perspective view schematically showing a state where electrically-conductive elastic bodies 22 are disposed on the opposing face 21a of the sheet-shaped member 21.

The electrically-conductive elastic bodies 22 extend in the Y-axis direction, and are formed so as to be arranged with a predetermined interval therebetween in the X-axis direction. The electrically-conductive elastic bodies 22 are formed on the opposing face 21a of the sheet-shaped member 21, at positions opposing the electrically-conductive elastic bodies 12 on the sheet-shaped member 11. Each electrically-conductive elastic body 22 has, in a plan view, the same size and shape as those of the electrically-conductive elastic body 12, and is formed from the same material as that of the electrically-conductive elastic body 12. Similar to the electrically-conductive elastic body 12, the electrically-conductive elastic body 22 is formed on the opposing face 21a of the sheet-shaped member 21 by a predetermined printing method. At an end portion on the Y-axis negative side of each electrically-conductive elastic body 22, a cable 22a electrically connected to the electrically-conductive elastic body 22 is set.

As shown in FIG. 2B, at positions of grooves 31 extending in the X-axis direction, each electrically-conductive elastic body 22 extends in the Y-axis direction along the shape of the grooves 31. Between adjacent two electrically-conductive elastic bodies 22, a groove 31 extending in the Y-axis direction is positioned.

FIG. 3 is a perspective view schematically showing a state where the structure in FIG. 2B is set on the structure in FIG. 1B.

The structure shown in FIG. 2B is disposed from above (the Z-axis positive side) the structure shown in FIG. 1B. At this time, the sheet-shaped member 11 and the sheet-shaped member 21 are disposed such that: the opposing face 11a and the opposing face 21a face each other; and the electrically-conductive elastic bodies 12 and the electrically-conductive elastic bodies 22 are superposed with each other. Then, outer peripheral four sides of the sheet-shaped member 21 are connected to the outer peripheral four sides of the sheet-shaped member 11 with a silicone rubber-based adhesive, a thread, or the like, whereby the sheet-shaped member 11 and the sheet-shaped member 21 are fixed to each other. Accordingly, the six conductor wires 13 are sandwiched by the three electrically-conductive elastic bodies 12 and the three electrically-conductive elastic bodies 22. Accordingly, the load sensor 1 is completed as shown in FIG. 3.

Here, in the load sensor 1, in a plan view, a plurality of the sensor parts A arranged in a matrix shape are formed. In the example shown in FIG. 3, a total of nine sensor parts A arranged in the X-axis direction and the Y-axis direction are formed. One sensor part A is positioned at an intersection of the electrically-conductive elastic bodies 12, 22 and a pair of the conductor wires 13. One sensor part A includes the electrically-conductive elastic bodies 12, 22, two conductor wires 13, and the sheet-shaped member 21 in the vicinity of intersection. When the load sensor 1 is set on a predetermined installation surface, and a load is applied to an upper face 21b (the face on the Z-axis positive side) of the sheet-shaped member 21 forming the sensor part A, the capacitance between the electrically-conductive elastic bodies 12, 22 and a pair of electrically-conductive members 13a changes, and the load is detected based on the capacitance.

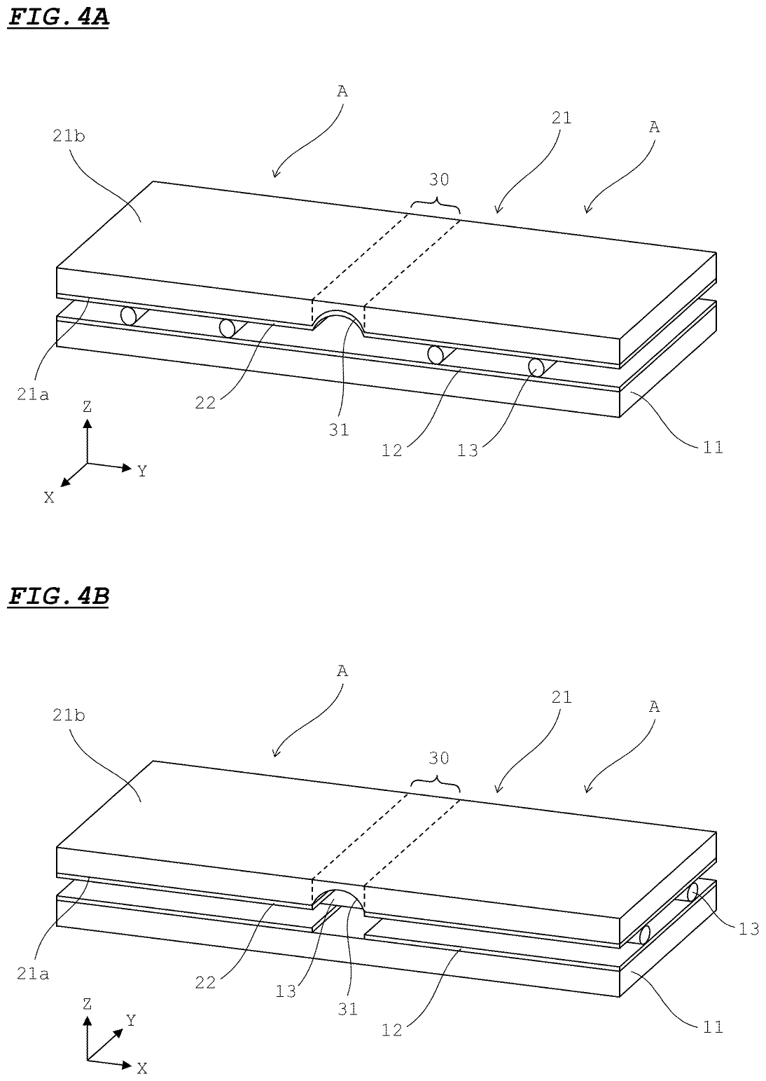

FIG. 4A is a perspective view schematically showing a cross section of two sensor parts A adjacent to each other in the Y-axis direction, along a Y-Z plane at the center position in the X-axis direction. FIG. 4B is a perspective view schematically showing a cross section of two sensor parts A adjacent to each other in the X-axis direction, along an X-Z plane at the center position in the Y-axis direction.

As shown in FIGS. 4A, 4B, between two sensor parts A adjacent to each other in the Y-axis direction, and between two sensor parts A adjacent to each other in the X-axis direction, a buffer part 30 is provided. Between the adjacent two sensor parts A, the buffer part 30 suppresses displacement of the upper face 21b due to a load applied to one sensor part A from being propagated to another sensor part A. Specifically, the rigidity of the sheet-shaped member 21 in the buffer part 30 is lower than the rigidity of the sheet-shaped member 21 in the sensor part A.

The buffer part 30 of Embodiment 1 is implemented by the sheet-shaped member 21 between adjacent two sensor parts A. In Embodiment 1, the cross-sectional shape of the buffer part 30 is different from the cross-sectional shape of the sheet-shaped member 21 in the sensor part A, whereby the rigidity of the buffer part 30 is lower than the rigidity of the sheet-shaped member 21 in the sensor part A. More specifically, the groove 31 whose cross section has an arc shape is formed in the opposing face 21a, to cause the sheet-shaped member 21 to have an arch shape, whereby the buffer part 30 of Embodiment 1 is formed. That is, in Embodiment 1, the thickness of the sheet-shaped member 21 in the buffer part 30 is smaller than the thickness of the sheet-shaped member 21 in the sensor part A, and the buffer part 30 has a shape in which a part of the sheet-shaped member 21 is cut off. In addition, the buffer part 30 of Embodiment 1 has a shape that is symmetric in the X-axis direction and the Y-axis direction.

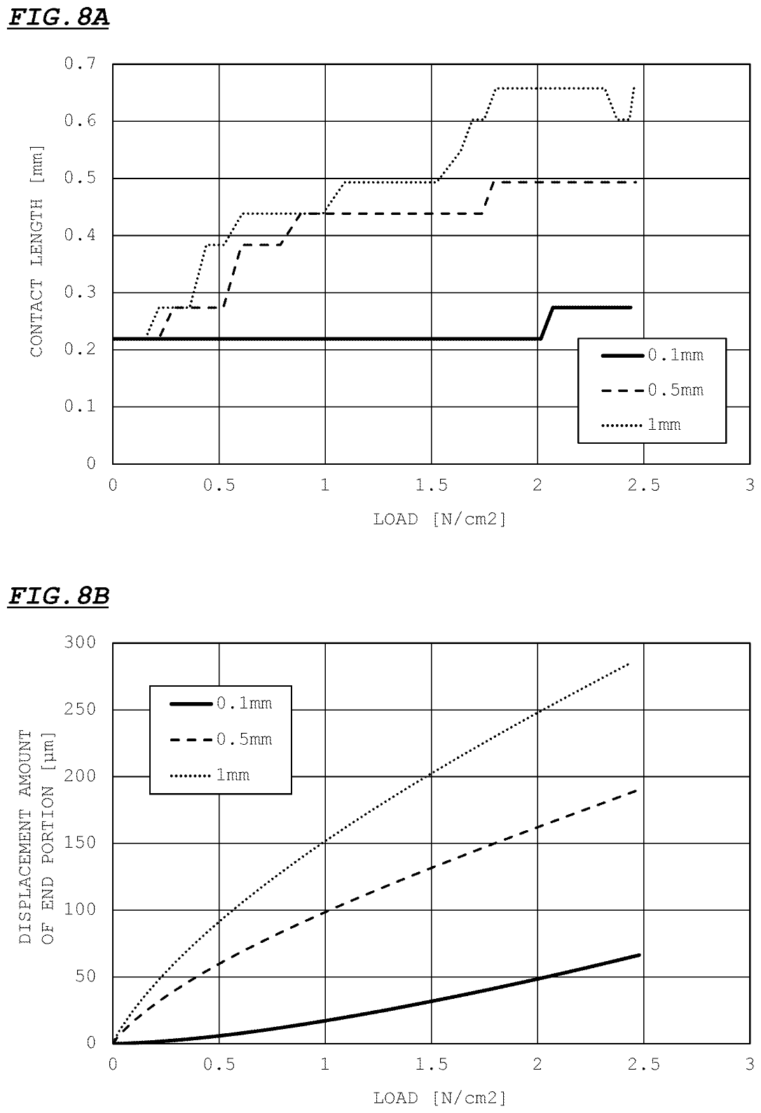

It is preferable that the shape of the buffer part 30 is set such that the moment of inertia of area in the buffer part 30 is not greater than ⅛ of the moment of inertia of area in the buffer part 30 when the sheet-shaped member 21 is disposed as in the sensor part A. That is, in the case of Embodiment 1, it is preferable that the shape of the buffer part 30 is set such that the average thickness of the sheet-shaped member 21 in the buffer part 30 becomes not greater than ½ of the thickness of the sheet-shaped member 21 in the sensor part A. This will be described later based on simulation results shown in FIGS. 8A, 8B.

As shown in FIG. 4A, in the groove 31 of the buffer part 30 provided between two sensor parts A adjacent to each other in the Y-axis direction, the electrically-conductive elastic body 22 is formed so as to connect the two sensor parts A. On the other hand, as shown in FIG. 4B, in the groove 31 of the buffer part 30 provided between two sensor parts A adjacent to each other in the X-axis direction, the electrically-conductive elastic body 22 is not formed. This is because in the case of FIG. 4B, the band-like electrically-conductive elastic bodies 12, 22 opposing each other extend in the Y-axis direction.

FIGS. 5A, 5B are each a cross-sectional view schematically showing a sensor part A viewed in the X-axis negative direction. FIG. 5A shows a state where no load is applied, and FIG. 5B shows a state where a load is applied.

As shown in FIGS. 5A, 5B, the conductor wire 13 is composed of an electrically-conductive member 13a and a dielectric body 13b formed on the electrically-conductive member 13a. The electrically-conductive member 13a is a wire member having a linear shape, and the dielectric body 13b covers the surface of the electrically-conductive member 13a. In FIGS. 5A, 5B, the face on the Z-axis negative side of the sheet-shaped member 11 is set on the installation surface.

As shown in FIG. 5A, when no load is applied, the force applied between the electrically-conductive elastic body 12 and the conductor wire 13 and the force applied between the electrically-conductive elastic body 22 and the conductor wire 13 are substantially zero. From this state, as shown in FIG. 5B, when a load is applied in the downward direction to the upper face 21b of the sheet-shaped member 21 corresponding to the sensor part A, the electrically-conductive elastic bodies 12, 22, the sheet-shaped member 11, and the sheet-shaped member 21 are deformed by the conductor wire 13.

As shown in FIG. 5B, when a load is applied, the conductor wire 13 is brought close to the electrically-conductive elastic bodies 12, 22 so as to be wrapped by the electrically-conductive elastic bodies 12, 22, and the contact area between the conductor wire 13 and the electrically-conductive elastic bodies 12, 22 increases. Accordingly, the capacitance between the electrically-conductive member 13a and the electrically-conductive elastic body 12 and the capacitance between the electrically-conductive member 13a and the electrically-conductive elastic body 22 change. Then, the capacitance regarding the two conductor wires 13 included in the sensor part A is detected, whereby the load applied to the sensor part A is calculated.

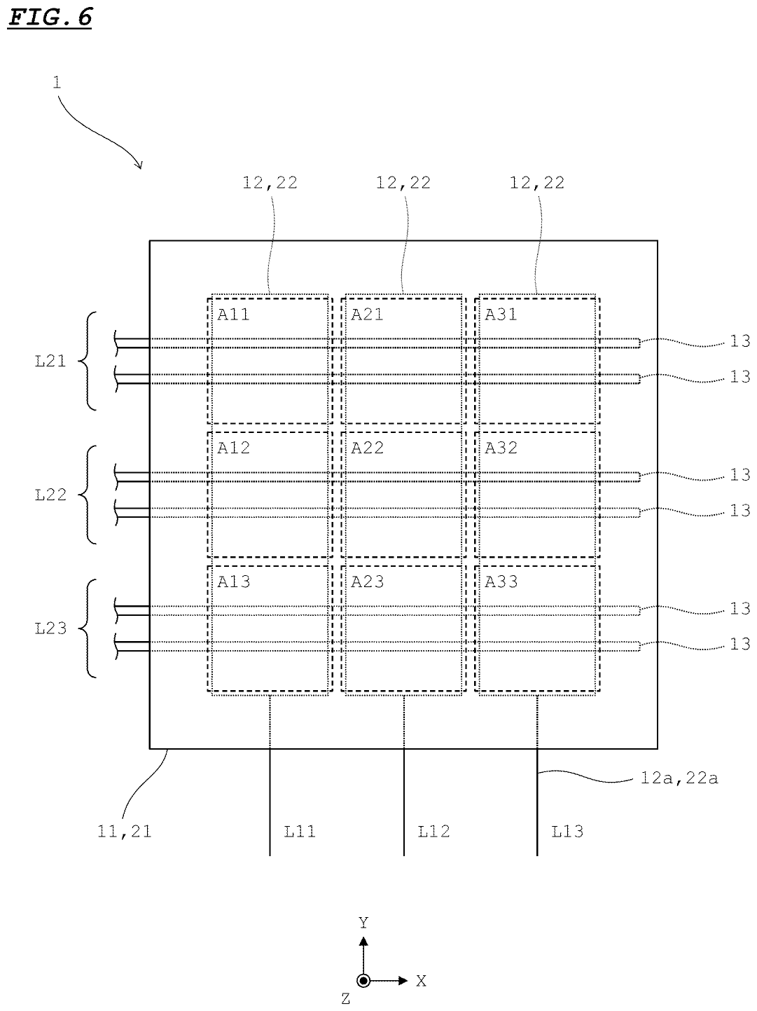

FIG. 6 is a plan view schematically showing a configuration of the inside of the load sensor 1 viewed in the Z-axis negative direction. In FIG. 6, the grooves 31 and the threads 14 are not shown.

In a measurement region of the load sensor 1, nine sensor parts A arranged in the X-axis direction and the Y-axis direction are set. The nine sensor parts A correspond to nine positions where the electrically-conductive elastic bodies 12, 22 and sets of adjacent two conductor wires 13 (pairs of the conductor wires 13) cross each other. In FIG. 6, at the nine positions, nine sensor parts A11, A12, A13, A21, A22, A23, A31, A32, A33 in each of which the capacitance changes in accordance with a load are formed.

Each sensor part includes the electrically-conductive elastic bodies 12, 22 and a pair of the conductor wires 13, the pair of the conductor wires 13 forms one pole (e.g., positive pole) for capacitance, and the electrically-conductive elastic bodies 12, 22 form the other pole (e.g., negative pole) for capacitance. That is, the electrically-conductive members 13a (see FIGS. 5A, 5B) in the pair of the conductor wires 13 form one electrode of the load sensor 1 (capacitance-type load sensor), the electrically-conductive elastic bodies 12, 22 form the other electrode of the load sensor 1 (capacitance-type load sensor), and the dielectric bodies 13b (see FIGS. 5A, 5B) in the pair of the conductor wires 13 correspond to a dielectric body that defines the capacitance in the load sensor 1 (capacitance-type load sensor).

When a load is applied in the Z-axis direction to each sensor part, the pair of the conductor wires 13 are wrapped by the electrically-conductive elastic bodies 12, 22. Accordingly, the contact area between the pair of the conductor wires 13 and the electrically-conductive elastic bodies 12, 22 changes, and the capacitance between the electrically-conductive members 13a of the pair of the conductor wires 13 and the electrically-conductive elastic bodies 12, 22 changes.

End portions on the X-axis negative side of each pair of the conductor wires 13 and end portions on the Y-axis negative side of the cables 12a, 22a are connected to a detection circuit set for the load sensor 1. The electrically-conductive members 13a in the pair of the conductor wires 13 are connected to each other in the detection circuit, and the cables 12a, 22a are connected to each other in the detection circuit.

As shown in FIG. 6, the cables 12a, 22a drawn from the three sets of the electrically-conductive elastic bodies 12, 22 will be referred to as lines L11, L12, L13, and the electrically-conductive members 13a in the three pairs of the conductor wires 13 will be referred to as lines L21, L22, L23. The positions at which the electrically-conductive elastic bodies 12, 22 connected to the line L11 cross the lines L21, L22, L23 are the sensor parts A11, A12, A13, respectively. The positions at which the electrically-conductive elastic bodies 12, 22 connected to the line L12 cross the lines L21, L22, L23 are the sensor parts A21, A22, A23, respectively. The positions at which the electrically-conductive elastic bodies 12, 22 connected to the line L13 cross the lines L21, L22, L23 are the sensor parts A31, A32, A33, respectively.

When a load is applied to the sensor part A11, the contact area between the electrically-conductive members 13a of the pair of the conductor wires 13 and the electrically-conductive elastic bodies 12, 22 increases in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

According to Embodiment 1, as shown in FIGS. 4A, 4B, the buffer part 30 is provided between adjacent two sensor parts A. Accordingly, when the upper face 21b of one sensor part A is pressed from above, deformation, in accordance with deformation of the upper face 21b in the one sensor part A, of the upper face 21b in the other sensor part A is suppressed. Therefore, false detection of a load in the other sensor part A can be suppressed.

Next, verification of effects of the buffer part 30 performed by the inventors will be described.

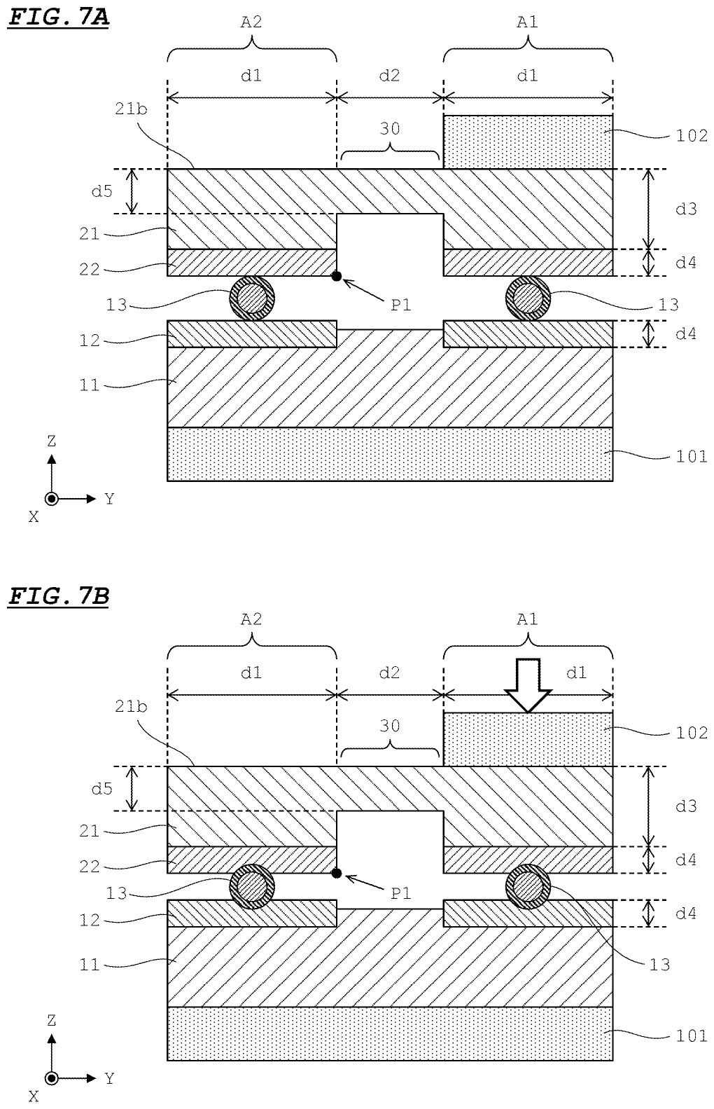

FIGS. 7A, 7B each schematically show a configuration of the load sensor 1 of Embodiment 1 used in the verification. FIGS. 7A, 7B each schematically show a cross section viewed in the X-axis negative direction.

As shown in FIGS. 7A, 7B, in the load sensor 1 of Embodiment 1 used in the verification, two electrically-conductive elastic bodies 12 were disposed on the upper face of the sheet-shaped member 11 and two electrically-conductive elastic bodies 22 were disposed on the lower face of the sheet-shaped member 21. The conductor wires 13 were disposed between the electrically-conductive elastic bodies 12 and the electrically-conductive elastic bodies 22, to form two sensor parts A arranged in the Y-axis direction. Hereinafter, the sensor part A on the Y-axis positive side will be referred to as a sensor part A1 and the sensor part A on the Y-axis negative side will be referred to as a sensor part A2. The lower face of the sheet-shaped member 11 was set on a base 101, and the upper face 21b of the sensor part A1 was pressed by a presser 102.

A width d1 in the Y-axis direction of the electrically-conductive elastic bodies 12, 22 was set to 5 mm. A width d2 in the Y-axis direction of the buffer part 30 between the two sensor parts A1, A2 was set to 2 mm. A thickness d3 of the sheet-shaped member 21 was set to 1 mm. A thickness d4 of the electrically-conductive elastic bodies 12, 22 was set to 0.1 mm. In the present verification, instead of forming the groove 31 in the sheet-shaped member 21, a rectangular groove was formed, and the thickness of the sheet-shaped member 21 in the buffer part 30 was made smaller than the thickness of the sheet-shaped member 21 in the sensor parts A1, A2. That is, the thickness of the sheet-shaped member 21 in the buffer part 30 was made constant in the width direction of the groove. Then, a thickness d5 of the buffer part 30 (the sheet-shaped member 21 between the two sensor parts A1, A2) was changed in three levels of 1 mm, 0.5 mm, and 0.1 mm.

When the thickness d5 was 1 mm, the thickness d5 of the buffer part 30 was the same as the thickness d3 of the sheet-shaped member 21. Therefore, this corresponds to a case where the buffer part 30 was not provided between the two sensor parts A1, A2.

In the present verification, the thickness d5 of the buffer part 30 was changed in the three levels, and in each case, a load was applied to the sensor part A1 by the presser 102 as shown in FIG. 7B. Then, in the sensor part A2, the contact length (length of the arc when viewed in the X-axis direction) between the conductor wire 13 and the electrically-conductive elastic bodies 12, 22, and the displacement amount (movement distance) in the Z-axis negative direction of an end portion P1 on the Y-axis positive side at the lower face of the electrically-conductive elastic body 22 was measured by simulation. The displacement amount of the end portion P1 when no load was applied as shown in FIG. 7A was defined as 0.

FIG. 8A is a simulation result showing a relationship between: the contact length between the conductor wire 13 on the Y-axis negative side and the electrically-conductive elastic bodies 12, 22; and the load applied to the sensor part A1 by the presser 102. In FIG. 8A, the horizontal axis represents the load (N/cm²) and the vertical axis represents the contact length (mm). In FIG. 8A, due to the relationship with the resolving power of the value in the vertical axis in the simulation, there are flat portions in each graph, but in actuality, in the flat portions as well, the contact length increases in association with increase in the load.

As shown in FIG. 8A, the smaller the thickness d5 of the buffer part 30 became as compared with the thickness d3 (=1 mm) of the sheet-shaped member 21 in the sensor parts A1, A2, the smaller the contact length between the conductor wire 13 and the electrically-conductive elastic bodies 12, 22 in the sensor part A2 became. That is, it was found that, when the thickness d5 of the buffer part 30 is made small, even if a load is applied to the sensor part A1, the contact length, in the sensor part A2, is less likely to change from the contact length (around 0.22 mm) of the case where the load is 0. Therefore, it can be said that, when the thickness d5 of the buffer part 30 is made small, the capacitance becomes less likely to change in the sensor part A2, whereby false detection of a load in the sensor part A2 is suppressed.

FIG. 8B is a simulation result showing a relationship between: the displacement amount in the Z-axis negative direction of the end portion P1 at the lower face of the electrically-conductive elastic body 22 on the Y-axis negative side; and the load applied by the presser 102. In FIG. 8B, the horizontal axis represents the load (N/cm²) and the vertical axis represents the displacement amount (μm) of the end portion P1.

As shown in FIG. 8B, the smaller the thickness d5 of the buffer part 30 became as compared with the thickness d3 (=1 mm) of the sheet-shaped member 21 in the sensor parts A1, A2, the smaller the displacement amount of the end portion P1 became. From this result, it was found that, even when a load is applied to the sensor part A1, the end portion P1 of the sensor part A2 is less likely to move in the Z-axis negative direction. In this case as well, it can be said that, when the thickness d5 of the buffer part 30 is made small, the capacitance becomes less likely to change in the sensor part A2, whereby false detection of a load in the sensor part A2 is suppressed.

When the thickness of the sheet-shaped member 21 changes, the moment of inertia of area of the sheet-shaped member 21 becomes small at a proportion of a cube of the ratio of the thickness after the change to the thickness before the change. Therefore, when the thickness of the sheet-shaped member 21 in the buffer part 30 becomes ½ of the thickness of the sheet-shaped member 21 in the sensor parts A1, A2, the moment of inertia of area in the buffer part 30 becomes ⅛ of the moment of inertia of area in the sensor parts A1, A2. The moment of inertia of area is an index indicating the difficulty in deformation of the sheet-shaped member 21, and the smaller the moment of inertia of area is, the softer (rigidity is lower) the sheet-shaped member 21 is.

With reference to the simulation results in FIGS. 8A, 8B, when the thickness of the sheet-shaped member 21 in the buffer part 30 is not greater than 0.5 mm, the contact length and the displacement amount of the end portion P1 in the sensor part A2 each decrease to not greater than 80% as compared with those when the buffer part 30 is not provided.

Therefore, it can be said that, when the thickness of the sheet-shaped member 21 in the buffer part 30 is set to not greater than 0.5 mm, displacement of the upper face at the time of load application in one sensor part A can be effectively suppressed from influencing the sensor part A adjacent thereto. When the thickness of the sheet-shaped member 21 in the buffer part 30 is 0.5 mm, this thickness is ½ of the thickness (1 mm) of the sheet-shaped member 21 in the sensor part A, and the moment of inertia of area due to this thickness becomes ⅛ of the moment of inertia of area of the sheet-shaped member 21 in the sensor part A.

Therefore, when the cross-sectional shape of the sheet-shaped member 21 in the buffer part 30 is set such that the moment of inertia of area in the buffer part 30 becomes ⅛ of the moment of inertia of area in the sensor part A, displacement of the upper face 21b at the time of load application in one sensor part A can be effectively suppressed from influencing the sensor part A adjacent thereto.

### Effect of Embodiment 1

According to Embodiment 1, the following effects are exhibited.

As shown in FIGS. 4A, 4B, the buffer part 30 is disposed between one sensor part A (first sensor part) and another sensor part A (second sensor part). When a load is applied to the one sensor part A (first sensor part), the buffer part 30 suppresses displacement of the upper face 21b due to the load applied to the one sensor part A (first sensor part) from being propagated to the other sensor part A (second sensor part).

With this configuration, as shown in the verification in FIG. 7A to FIG. 8B, when a load has been applied only to the one sensor part A (first sensor part), deformation, in accordance with deformation of the upper face 21b in the one sensor part A (first sensor part), of the upper face 21b in the other sensor part A (second sensor part) is suppressed by the buffer part 30. Therefore, in this case, change in the contact area between the electrically-conductive elastic bodies 12, 22 and the conductor wire 13 (dielectric body 13b) in the other sensor part A (second sensor part) is suppressed. Therefore, false detection of a load in the other sensor part A (second sensor part) can be suppressed.

The rigidity of the buffer part 30 is lower than the rigidity of the sheet-shaped member 21 in the sensor part A. With this configuration, in adjacent two sensor parts A, deformation of the sheet-shaped member 21 in one sensor part A is absorbed by the buffer part 30, and is less likely to be propagated to the sheet-shaped member 21 in the other sensor part A. Therefore, false detection in the other sensor part A can be avoided.

### Modification 1 of Embodiment 1

In Embodiment 1 above, as shown in FIGS. 4A, 4B, the sheet-shaped member 21 in the buffer part 30 has an arch shape in which a part of the sheet-shaped member 21 is cut off by the groove 31, or as shown in FIGS. 7A, 7B, the thickness of the sheet-shaped member 21 in the buffer part 30 is smaller than the thickness of the sheet-shaped member 21 in the sensor part A. However, the shape of the buffer part 30 is not limited to the above shapes, and may be shapes as in Modifications 1 to 3 shown below.

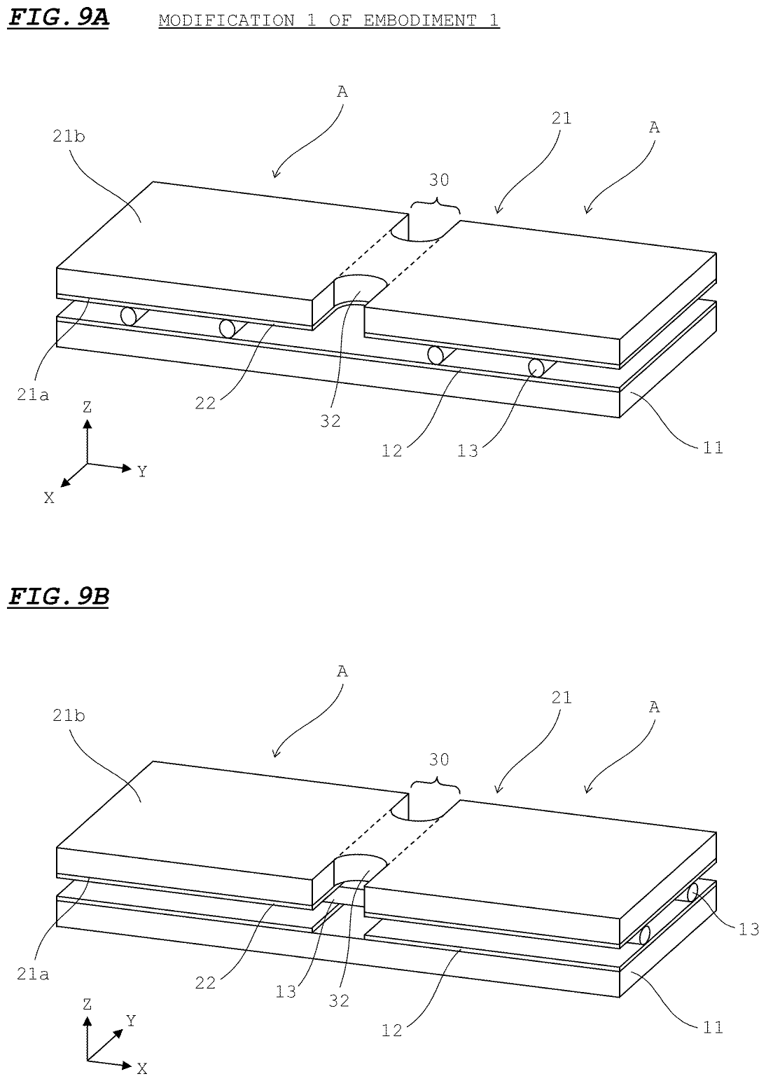

FIGS. 9A, 9B are perspective views schematically showing cross sections of the load sensor 1 along a Y-Z plane and an X-Z plane, respectively, according to Modification 1 of Embodiment 1.

In the present modification, as shown in FIG. 9A, between the sensor parts A arranged in the Y-axis direction, the width in the X-axis direction of the sheet-shaped member 21 in the buffer part 30 is short, and as shown in FIG. 9B, between the sensor parts A arranged in the X-axis direction, and the width in the Y-axis direction of the sheet-shaped member 21 in the buffer part 30 is short. That is, the buffer part 30 is implemented by the sheet-shaped member 21 in which a hole 32 penetrating in the Z-axis direction is formed, and due to the formation of the hole 32, the widths in the X-axis direction and the Y-axis direction of the sheet-shaped member 21 in the buffer part 30 are short.

In the present modification as well, the shape of the sheet-shaped member 21 in the buffer part 30 is set such that the moment of inertia of area of the sheet-shaped member 21 in the buffer part 30 becomes not greater than ⅛ of the moment of inertia of area of the sheet-shaped member 21 in the sensor part A. When the area of the sheet-shaped member 21 changes, the moment of inertia of area of the sheet-shaped member 21 becomes small in accordance with the ratio of the area after the change to the area before the change. Therefore, when the area in a plan view of the buffer part 30 in a case where the hole 32 is formed in the buffer part 30 is set to not greater than ⅛ of the area in a plan view of the buffer part 30 in a case where the hole 32 is not formed in the buffer part 30, the moment of inertia of area of the sheet-shaped member 21 in the buffer part 30 can be set so as to become not greater than ⅛ of the moment of inertia of area of the sheet-shaped member 21 in the sensor part A.

In the present modification as well, the rigidity of the sheet-shaped member 21 in the buffer part 30 becomes lower than the rigidity of the sheet-shaped member 21 in the sensor part A. Accordingly, deformation, in accordance with deformation of the upper face 21b in one sensor part A, of the upper face 21b in the other sensor part A is suppressed. Therefore, false detection of a load in the sensor part A where no load is applied can be suppressed.

### Modification 2 of Embodiment 1

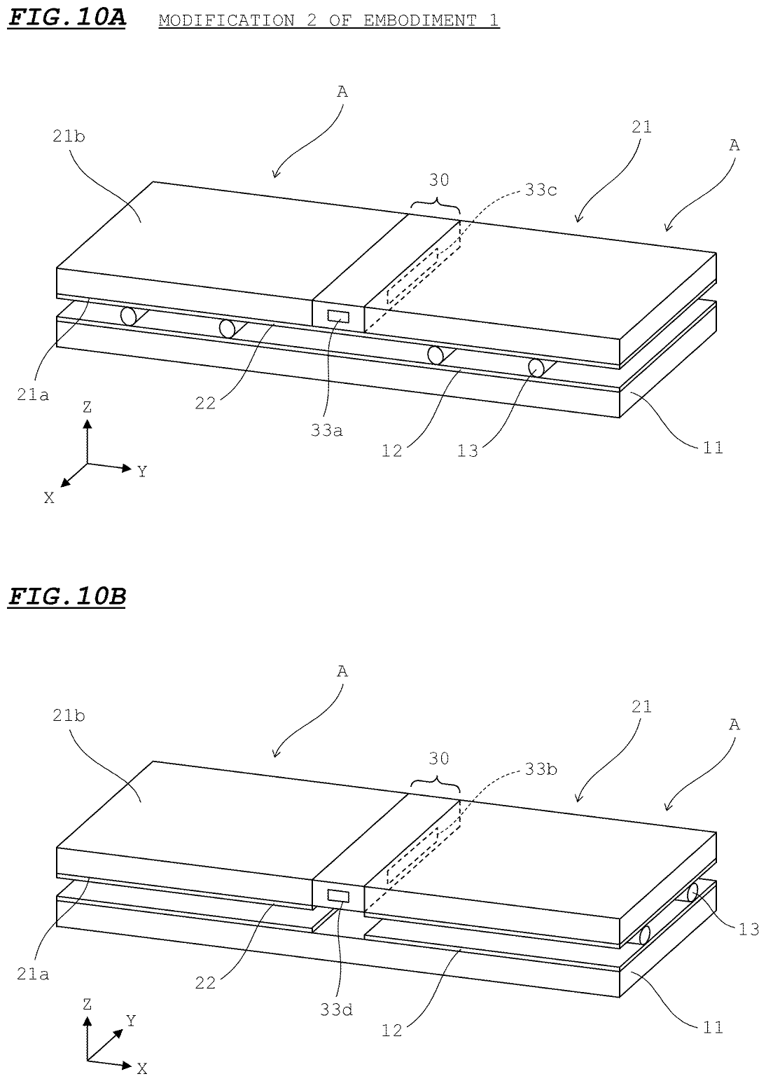

FIGS. 10A, 10B are perspective views schematically showing cross sections of the load sensor 1 along a Y-Z plane and an X-Z plane, respectively, according to Modification 2 of Embodiment 1.

The buffer part 30 of the present modification is implemented by the sheet-shaped member 21 in which a hole 33a, 33b penetrating in the X-axis direction and a hole 33c, 33d penetrating in the Y-axis direction are formed. The hole 33a extends in the X-axis direction between two sensor parts A arranged in the Y-axis direction, and the hole 33c extends in the Y-axis direction between sensor parts A arranged in the Y-axis direction. The hole 33b extends in the X-axis direction between two sensor parts A arranged in the X-axis direction, and the hole 33d extends in the Y-axis direction between two sensor parts A arranged in the X-axis direction.

In the present modification as well, the shape of the buffer part 30 is set such that the moment of inertia of area of the sheet-shaped member 21 in the buffer part 30 becomes not greater than ⅛ of the moment of inertia of area in the buffer part 30 when the sheet-shaped member 21 is disposed as in the sensor part A. That is, the average thickness of the buffer part 30 when the hole 33a, 33b, 33c, 33d is formed in the buffer part 30 is set to not greater than ½ of the thickness of the buffer part 30 when the hole 33a, 33b, 33c, 33d is not formed in the buffer part 30.

In the present modification, members similar to the sheet-shaped member 21 are separately shaped so as to match the shape of the buffer part 30 between sensor parts A, and the holes 33a, 33b, 33c, 33d are formed in advance in the members. Then, the sheet-shaped member 21 corresponding to each sensor part A is set to a corresponding member by an adhesive or a thread. However, the formation method for the buffer part 30 is not limited thereto, and another method may be used as appropriate. For example, when only the holes 33a, 33d are provided, the holes 33a, 33d may be formed in one sheet-shaped member 21 extending across all the sensor parts A, instead of separately shaping the sheet-shaped members 21 corresponding to the buffer parts 30.

In the present modification as well, the rigidity of the sheet-shaped member 21 in the buffer part 30 becomes lower than the rigidity of the sheet-shaped member 21 in the sensor part A. Accordingly, false detection of a load in the sensor part A where no load is applied can be suppressed.

### Modification 3 of Embodiment 1

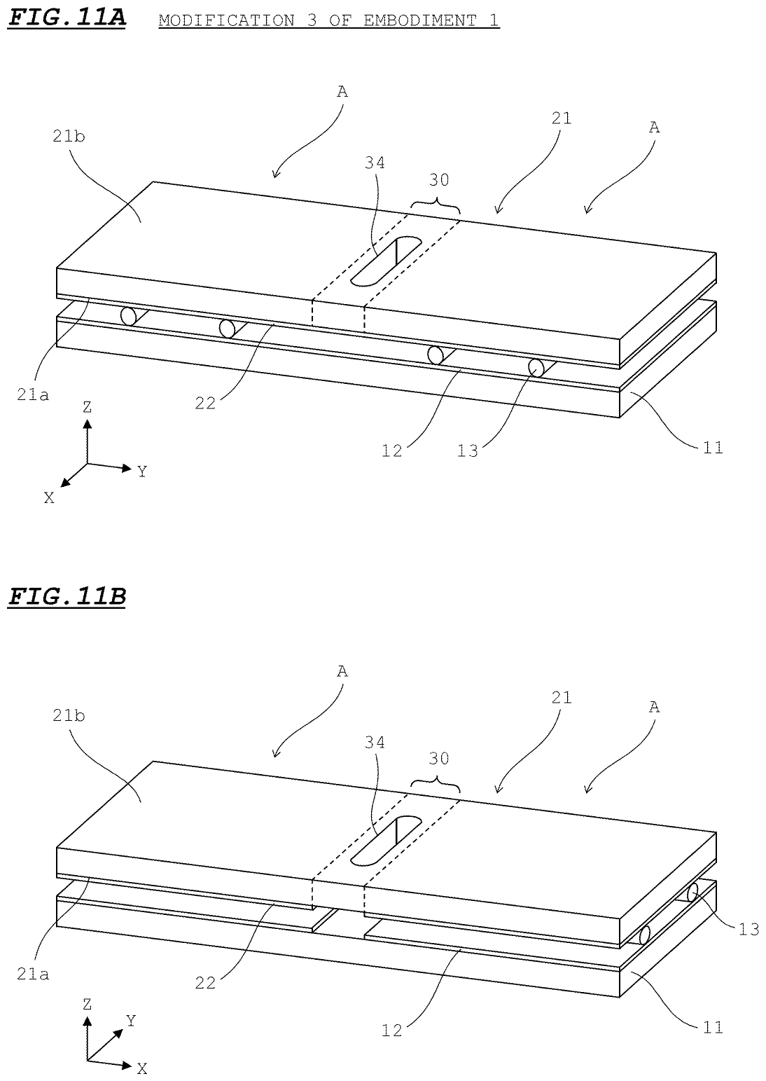

FIGS. 11A, 11B are perspective views schematically showing cross sections of the load sensor 1 along a Y-Z plane and an X-Z plane, respectively, according to Modification 3 of Embodiment 1.

The buffer part 30 of the present modification is implemented by the sheet-shaped member 21 in which a hole 34 penetrating in the Z-axis direction is formed. In the present modification as well, the shape of the buffer part 30 is set such that the moment of inertia of area of the sheet-shaped member 21 in the buffer part 30 becomes not greater than ⅛ of the moment of inertia of area in the buffer part 30 when the sheet-shaped member 21 is disposed as in the sensor part A. That is, the area in a plan view of the buffer part 30 when the hole 34 is formed in the buffer part 30 is set to not greater than ⅛ of the area in a plan view of the buffer part 30 when the hole 34 is not formed in the buffer part 30.

In the present modification as well, the rigidity of the sheet-shaped member 21 in the buffer part 30 becomes lower than the rigidity of the sheet-shaped member 21 in the sensor part A. Accordingly, false detection of a load in the sensor part A where no load is applied can be suppressed.

### Embodiment 2

In Embodiment 1, the buffer part 30 is formed such that the shape of the sheet-shaped member 21 in the buffer part 30 is made different from the shape of the sheet-shaped member 21 in the sensor part A. In contrast to this, in Embodiment 2, the buffer part 30 is implemented by a member having an elastic modulus smaller than that of the sheet-shaped member 21.

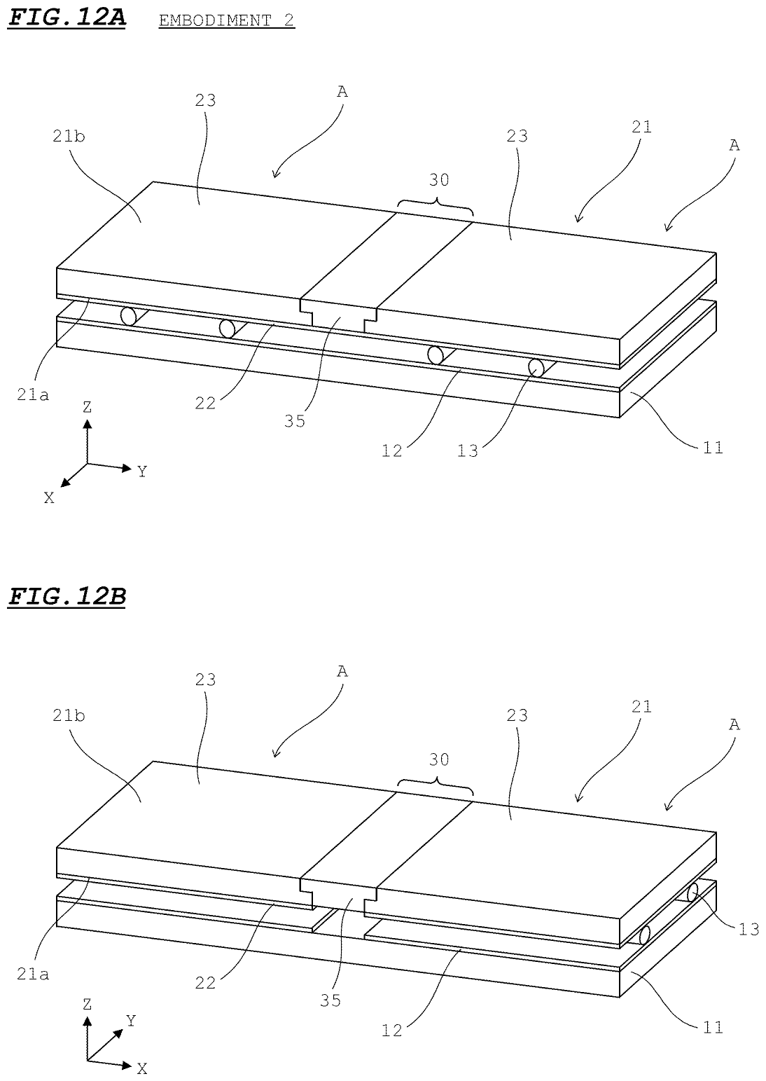

FIGS. 12A, 12B are perspective views schematically showing cross sections of the load sensor 1 along a Y-Z plane and an X-Z plane, respectively, according to Embodiment 2.

In Embodiment 2, the sheet-shaped member 21 is composed of: a member 23 forming the upper face 21b of the sensor part A; and a member 35 forming the buffer part 30. The member 35 fills the space between adjacent two sensor parts A without any gap. The member 35 is separately shaped so as to match the shape of the space between adjacent members 23, and set to these members 23 by an adhesive or a thread. The member 23 is formed with a material and a thickness similar to those of the sheet-shaped member 21 described in Embodiment 1. The member 35 is formed from a material having a low elastic modulus such as a non-electrically-conductive resin or a non-electrically-conductive rubber. The elastic modulus of the member 35 is smaller than the elastic modulus of the member 23. The thickness of the member 35 is the same as the thickness of the member 23. For example, when the member 23 is formed from a silicone rubber, the member 35 is formed from a urethane rubber, a urethane resin, a silicone rubber having an elastic modulus lower than that of said silicone rubber, or the like.

In general, the softness (lowness of rigidity) of a member is indicated by a value obtained by multiplying the moment of inertia of area by the elastic modulus. In the configuration in FIGS. 12A, 12B, since the thicknesses of the members 23, 35 are the same, the moments of inertia of area of the members 23, 35 are equal to each other. In contrast to this, the elastic modulus of the member 35 is smaller than the elastic modulus of the member 23, and thus, due to this difference in elastic modulus, the softness (lowness of rigidity) of the member 35 becomes higher than that of the member 23.

As shown in the simulation in Embodiment 1 above, it is preferable that the rigidity of the sheet-shaped member 21 in the buffer part 30 is not greater than ⅛ of the rigidity of the sheet-shaped member 21 in the sensor part A. Therefore, in the configuration shown in FIGS. 12A, 12B, it is desirable that the elastic modulus (the elastic modulus of the sheet-shaped member 21 in the buffer part 30) of the member 35 is not greater than ⅛ of the elastic modulus (the elastic modulus of the sheet-shaped member 21 in the sensor part A) of the member 23. Accordingly, displacement of the upper face 21b at the time of load application in one sensor part A can be effectively suppressed from influencing the sensor part A adjacent thereto. According to Embodiment 2, since the elastic modulus of the sheet-shaped member 21 in the buffer part 30 (the member 35) is smaller than the elastic modulus of the sheet-shaped member 21 in the sensor part A, the rigidity of the sheet-shaped member 21 in the buffer part 30 becomes lower than the rigidity of the sheet-shaped member 21 in the sensor part A. Accordingly, similar to Embodiment 1, deformation, in accordance with deformation of the upper face 21b in one sensor part A, of the upper face 21b in the other sensor part A is suppressed. Therefore, false detection of a load in the sensor part A where no load is applied can be suppressed.

### Modification 1 of Embodiment 2

In Embodiment 2 above, as shown in FIGS. 12A, 12B, the buffer part 30 is implemented by the member 35 having an elastic modulus lower than that of the member 23. However, the configuration in which the elastic modulus of the sheet-shaped member 21 in the buffer part 30 is made lower than the elastic modulus of the sheet-shaped member 21 in the sensor part A is not limited thereto, and another configuration may be adopted.

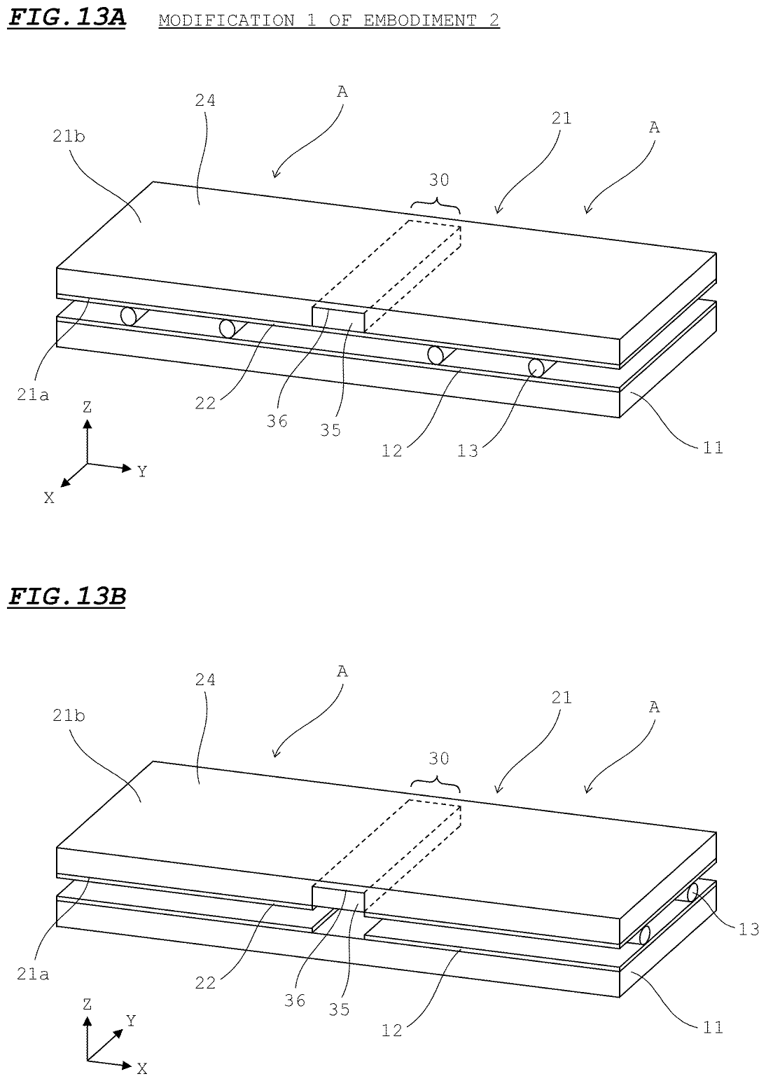

FIGS. 13A, 13B are perspective views schematically showing cross sections of the load sensor 1 along a Y-Z plane and an X-Z plane, respectively, according to Modification 1 of Embodiment 2.

In the present modification, the sheet-shaped member 21 is composed of: one member 24 forming the upper face 21b of the entirety of the load sensor 1; and the member 35 set in a recess 36 in the member 24. The member 24 is formed from a material similar to that of the member 23 in Embodiment 2. The thickness of the member 24 in the sensor part A is similar to that of the member 23 in Embodiment 2.

As shown in FIGS. 13A, 13B, in the member 24, between adjacent two sensor parts A, the recess 36 having a rectangular side face shape and extending perpendicularly to the direction in which these sensor parts A are adjacent to each other is formed by cutting. The depth of the recess 36 is constant. In the recess 36, the member 35 having an elastic modulus smaller than that of the member 24 is set by an adhesive or a thread. The member 35 is formed from a material having a low elastic modulus such as a non-electrically-conductive resin or a non-electrically-conductive rubber. For example, when the member 24 is formed from a silicone rubber, the member 35 is formed from a urethane rubber, a urethane resin, a silicone rubber having an elastic modulus lower than that of said silicone rubber, or the like.

In the configuration in FIGS. 13A, 13B, the buffer part 30 is composed of the member 35 and the member 24 at the position of the recess 36. The thickness of the sheet-shaped member 21 in the buffer part 30 and the thickness of the sheet-shaped member 21 in the sensor part A are the same.

In the present modification, owing to combination of both of decrease in the moment of inertia of area due to the recess 36 and decrease in the elastic modulus due to the member 35, the rigidity of the sheet-shaped member 21 in the buffer part 30 is lower than the rigidity of the sheet-shaped member 21 in the sensor part A. In the present modification as well, similar to Embodiments 1, 2 above, it is preferable that the rigidity of the sheet-shaped member 21 in the buffer part 30 becomes not greater than ⅛ of the rigidity of the sheet-shaped member 21 in the sensor part A.

In this case, in consideration of both of decrease in the moment of inertia of area due to the recess 36 and decrease in the elastic modulus due to the member 35, the shape of the recess 36 and the elastic modulus of the member 35 are set such that the rigidity (elastic modulus) of the sheet-shaped member 21 in the buffer part 30 becomes not greater than ⅛ of the elastic modulus of the sheet-shaped member 21 in the sensor part A. Accordingly, displacement of the upper face 21b at the time of load application in one sensor part A can be effectively suppressed from influencing the sensor part A adjacent thereto.

According to the present modification, since the moment of inertia of area and the elastic modulus of the sheet-shaped member 21 in the buffer part 30 (the member 35 and the member 24 above the member 35) are smaller than the moment of inertia of area and the elastic modulus of the sheet-shaped member 21 in the sensor part A, the rigidity of the buffer part 30 becomes lower than the rigidity of the sheet-shaped member 21 in the sensor part A. Accordingly, similar to Embodiment 2, false detection of a load in the sensor part A where no load is applied can be suppressed.

### Modification 2 of Embodiment 2

In Modification 2, another configuration example for decreasing the rigidity of the buffer part 30 is shown.

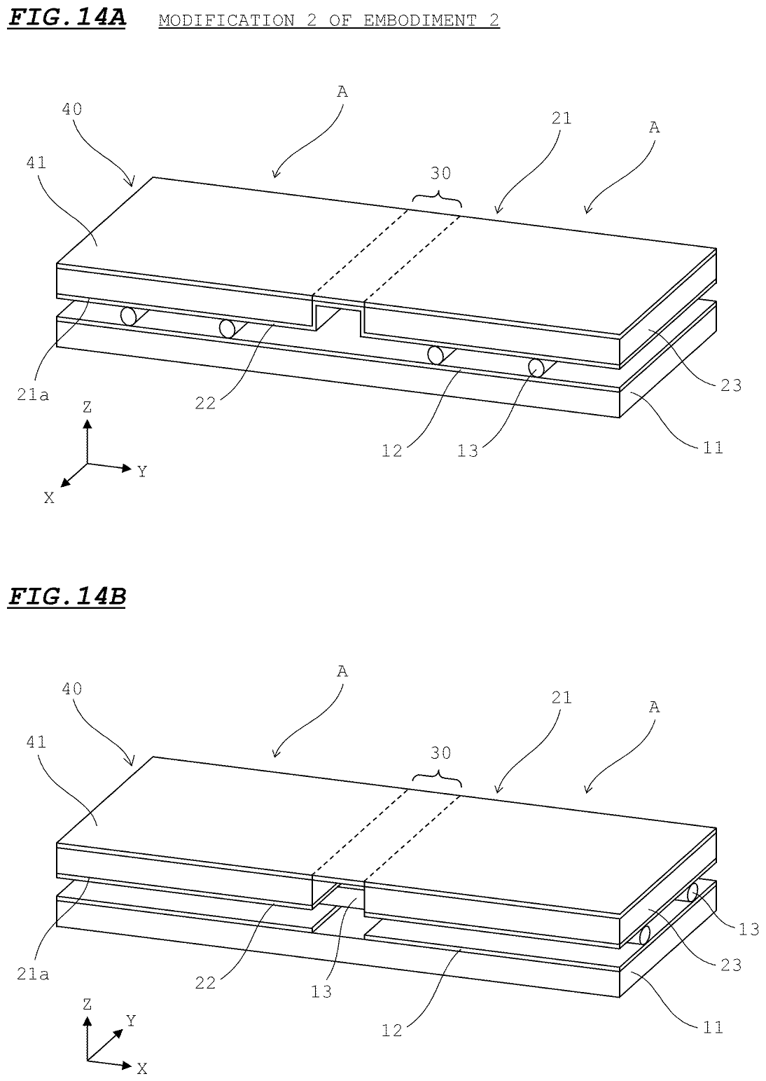

FIGS. 14A, 14B are perspective views schematically showing cross sections of the load sensor 1 along a Y-Z plane and an X-Z plane, respectively, according to Modification 2 of Embodiment 2.

In the present modification, the sheet-shaped member 21 is composed of: the member 23 positioned at each sensor part A; and one film-shaped member 40 covering the upper face 21b of the load sensor 1. The member 23 is formed with a material and a thickness similar to those of the member 23 of Embodiment 2. An upper face 41 of the film-shaped member 40 forms the upper face to which a load is applied in the load sensor 1. The film-shaped member 40 is set on the upper faces of a plurality of the members 23 by an adhesive or a thread. The elastic modulus of the film-shaped member 40 is smaller than the elastic modulus of the sheet-shaped member 21. The film-shaped member 40 is formed from a material having a low elastic modulus such as a non-electrically-conductive resin or a non-electrically-conductive rubber. For example, when the member 23 is formed from a silicone rubber, the film-shaped member 40 is formed from a urethane rubber, a urethane resin, a silicone rubber having an elastic modulus lower than that of said silicone rubber, or the like.

In the configuration in FIGS. 14A, 14B, the buffer part 30 is implemented by the film-shaped member 40 between adjacent two sensor parts A.

In the present modification as well, similar to Embodiments 1, 2 above, it is preferable that the rigidity of the sheet-shaped member 21 in the buffer part 30 becomes not greater than ⅛ of the rigidity of the sheet-shaped member 21 in the sensor part A. In this case, in consideration of the moment of inertia of area and the elastic modulus of the sheet-shaped member 21 in the region of the sensor part A composed of the lamination structure of the member 23 and the film-shaped member 40, and the moment of inertia of area and the elastic modulus of the sheet-shaped member 21 in the region of the buffer part 30 composed only of the film-shaped member 40, the thickness and the elastic modulus of the film-shaped member 40 are set such that the rigidity of the sheet-shaped member 21 (the film-shaped member 40) in the buffer part 30 becomes not greater than ⅛ of the rigidity of the sheet-shaped member 21 (the member 23 and the film-shaped member 40) in the sensor part A. Accordingly, displacement of the upper face 21b at the time of load application in one sensor part A can be effectively suppressed from influencing the sensor part A adjacent thereto. In this case, for example, it is desirable that the thickness of the film-shaped member 40 in the buffer part 30 is not greater than ½ of the thickness of the sheet-shaped member 21 in the sensor part A.

During production of the load sensor 1, one film-shaped member 40 is set on the upper faces of a plurality of the members 23 disposed with a space from each other. Then, on the face (the opposing face 21a) on the Z-axis negative side of the sheet-shaped member 21 composed of the plurality of the members 23 and the one film-shaped member 40, the electrically-conductive elastic bodies 22 extending in the Y-axis direction are formed by the printing method as described above. Further, as shown in FIG. 14A, in the buffer part 30, the electrically-conductive elastic body 22 is formed, through coating application, etc., on the side faces parallel to an X-Z plane of the member 23 and on the lower face of the film-shaped member 40 as well. Accordingly, in two sensor parts A adjacent to each other in the Y-axis direction, the electrically-conductive elastic bodies 22 disposed on the opposing face 21a of the sheet-shaped member 21 are connected to each other.

According to the present modification, the rigidity of the sheet-shaped member 21 (the film-shaped member 40) in the buffer part 30 is smaller than the rigidity of the sheet-shaped member 21 (the member 23 and the film-shaped member 40) in the sensor part A. Accordingly, similar to Embodiment 2, false detection of a load in the sensor part A where no load is applied can be suppressed.

### Other Modifications

The configuration of the load sensor 1 can be modified in various ways, in addition to the configurations shown in the embodiments above.

In Embodiment 1, the groove 31 has a cylindrical surface shape, but the shape of the groove 31 is not limited thereto. For example, the groove 31 may have a groove shape whose cross section is a V shape or a side face shape of a rectangular solid. The groove 31 may be provided only in a part between adjacent two sensor parts A.

In Modification 1 of Embodiment 1, the hole 32 whose end portion has an arc shape in a plan view is formed so as to reduce the width of the buffer part 30. However, the shape of the end portion of the hole 32 in a plan view is not limited thereto. For example, the shape of the end portion of the hole 32 may be a V shape or a quadrangular shape. The size in a plan view of the hole 32 is constant irrespective of the position in the Z-axis direction, but may be changed in accordance with the position in the Z-axis direction.

In Modification 2 of Embodiment 1, the hole 33a to 33d penetrating the sheet-shaped member 21 in the buffer part 30 is provided in the buffer part 30. However, one or more holes of the holes 33a to 33d may be formed in the sheet-shaped member 21 in the buffer part 30. However, as shown in FIG. 10A, in the case of the buffer part 30 between two sensor parts A adjacent to each other in the Y-axis direction, different from the case in FIG. 10B, the vicinity of the buffer part 30 is not supported by the conductor wires 13. Therefore, it is preferable that the holes 33a, 33c are provided.

The cross-sectional shape of the hole 33a to 33d is a quadrangular shape, but may be another shape such as a circular shape or a triangular shape. The number of the holes 33a to 33d is not limited to one, and a plurality of the holes 33a to 33d may be provided. The size of the cross-sectional shape in a Y-Z plane of the hole 33a, 33b and the size of the cross-sectional shape in an X-Z plane of the hole 33c, 33d need not necessarily be constant, and may be changed in accordance with the position in the extending direction. The hole 33a to 33d need not necessarily extend in a straight line shape, and may extend in a meandering manner. The hole 33a to 33d need not necessarily penetrate the region between adjacent two sensor parts A.

In Modification 3 of Embodiment 1, in the buffer part 30, one hole 34 penetrating, in the Z-axis direction, the sheet-shaped member 21 in the buffer part 30 is provided. However, the number of the holes 34 provided in the buffer part 30 is not limited to one and may be a plurality. The shape in a plan view of the hole 34 is not limited to the shape shown in FIGS. 11A, 11B, and may be another shape such as a circular shape or a quadrangular shape. The size of the cross-sectional shape in an X-Y plane of the hole 34 need not necessarily be constant, and may be changed in accordance with the position in the Z-axis direction. The hole 34 need not necessarily extend in a straight line shape in the Z-axis direction, and may extend in a meandering manner. The hole 34 need not necessarily penetrate the sheet-shaped member 21.

In Embodiment 1 and Modifications 1, 3 of Embodiment 1, the groove 31, the hole 32, or the hole 34 is formed in one sheet-shaped member 21, whereby the buffer part 30 is formed. However not limited thereto, a member that is similar to the sheet-shaped member 21 and that matches the shape of the buffer part 30 between sensor parts A may be separately shaped, the groove 31, the hole 32, or the hole 34 may be formed in the member in advance, and to the member, a member similar to the sheet-shaped member 21 corresponding to each sensor part A may be set by an adhesive or a thread.

In Embodiment 1 and Modifications 1 to 3 of Embodiment 1, the buffer part 30 is configured so as to be symmetric in the X-axis direction and the Y-axis direction, but need not necessarily be symmetric.

In Embodiment 2, the buffer part 30 is implemented by the member 35 disposed between adjacent two sensor parts A, and the connection portion between the member 35 and the member 23 is formed in a stepped shape. However, not limited thereto, the connection portion between the member 35 and the member 23 need not necessarily be formed in a stepped shape, and, for example, may be formed to be a plane perpendicular to the opposing direction of adjacent two sensor parts A. However, when the connection portion is formed in a stepped shape, the member 35 and the member 23 can be firmly connected. The member 35 may be provided only in a part between adjacent two sensor parts A. The elastic modulus of the member 35 need not necessarily be uniform.

In Embodiment 2, the groove 31, the hole 32, the hole 33a to 33d, or the hole 34 of Embodiment 1 and Modifications 1 to 3 of Embodiment 1 may be formed in the member 35. Then, the rigidity of the buffer part 30 is further reduced, and thus, false detection in the sensor part A can be further avoided.

In Modification 1 of Embodiment 2, the recess 36 formed in the buffer part 30 has a side face shape of a rectangular solid, but the shape of the recess 36 is not limited thereto. For example, the recess 36 may have a cylindrical surface shape, or may have a groove shape whose cross section is a V shape. The recess 36 may be provided only in a part between adjacent two sensor parts A.

In Modification 1 of Embodiment 2, the groove 31, the hole 32, the hole 33a to 33d, or the hole 34 of Embodiment 1 and Modifications 1 to 3 of Embodiment 1 may be formed in the structure composed of the member 35 and the member 24 above the member 35.

In Modification 2 of Embodiment 2, the elastic modulus of the film-shaped member 40 need not necessarily be uniform.

In Embodiments 1, 2 and the modifications above, the buffer part 30 is provided to both between two sensor parts A adjacent to each other in the X-axis direction and between two sensor parts A adjacent to each other in the Y-axis direction. However, the buffer part 30 may be provided in either one of them. However, in order to suppress false detection in all sensor parts A adjacent to a sensor part A to which a load has been applied, it is preferable that the buffer part 30 is provided both between two sensor parts A adjacent to each other in the X-axis direction and between two sensor parts A adjacent to each other in the Y-axis direction, as described above. In the buffer part 30 between two sensor parts A adjacent to each other in the Y-axis direction, the vicinity of the buffer part 30 is not supported by the conductor wires 13, as compared with the buffer part 30 between two sensor parts A adjacent to each other in the X-axis direction. Therefore, it is preferable that the buffer part 30 is provided between two sensor parts A adjacent to each other in the Y-axis direction.

In Embodiments 1, 2 and the modifications above, the buffer part 30 may include: the sheet-shaped member 21 disposed between adjacent two sensor parts A; and a support structure supporting, in the Z-axis positive direction, the sheet-shaped member 21 at the position. In this case, the support structure suppresses movement in the downward direction (the Z-axis negative direction) of the sheet-shaped member 21 disposed between adjacent two sensor parts A. Thus, in the sensor part A where no load is applied, unintentional movement in the downward direction of the sheet-shaped member 21 is suppressed. Therefore, false detection in the sensor part A where no load is applied can be suppressed.

In Embodiments 1, 2 above, the load sensor 1 includes six conductor wires 13, but may include one or more conductor wires 13. For example, the number of the conductor wires 13 included in the load sensor 1 may be one. The sensor part A of the load sensor 1 includes two conductor wires 13, but may include one or more conductor wires 13. For example, the number of the conductor wires 13 included in the sensor part A may be one.

In Embodiments 1, 2 above, the load sensor 1 includes three sets of the electrically-conductive elastic bodies 12, 22 opposed in the up-down direction, but may include at least one set of the electrically-conductive elastic bodies 12, 22. For example, the number of the sets of the electrically-conductive elastic bodies 12, 22 included in the load sensor 1 may be one.

In Embodiments 1, 2 above, the sensor part A includes one set of the electrically-conductive elastic bodies 12, 22 opposed in the up-down direction, and may include only either one of the electrically-conductive elastic bodies 12, 22. That is, only either one of the electrically-conductive elastic bodies 12, 22 may be disposed.

In Embodiments 1, 2 above, the pair of the conductor wires 13 in the sensor part A may be connected at an end portion on the X-axis positive side. For example, the pair of the conductor wires 13 passing one sensor part A may be formed by bending one conductor wire 13 extending in the X-axis direction.

In Embodiments 1, 2 above, the electrically-conductive elastic bodies 12, 22 and the conductor wire 13 cross each other at 90° in a plan view, but may cross at an angle other than 90°.

In Embodiments 1, 2 above, the cross-sectional shape of the electrically-conductive member 13a is a circle, but the cross-sectional shape of the electrically-conductive member 13a is not limited to a circle and may be another shape such as an ellipse or a pseudo circle. The electrically-conductive member 13a may be implemented by a twisted wire obtained by twisting a plurality of electrically-conductive members.

In Embodiments 1, 2 above, the dielectric body 13b is disposed so as to cover the electrically-conductive member 13a, but instead, the dielectric body 13b may be disposed on the opposing face of the electrically-conductive elastic bodies 12, 22. In this case, when a load is applied to the sensor part A, the electrically-conductive member 13a relatively moves toward the electrically-conductive elastic bodies 12, 22, and the contact area between the electrically-conductive member 13a and the dielectric body 13b changes. Accordingly, the capacitance between the electrically-conductive elastic bodies 12, 22 and the electrically-conductive member 13a changes, and thus, the load in each sensor part A can be detected.

In Embodiments 1, 2 above, instead of the electrically-conductive elastic bodies 12, 22 and the conductor wire 13, the sensor part A may include an electrode, a dielectric body disposed on the surface of the electrode, and an electrically-conductive elastic body disposed so as to oppose the dielectric body. A plurality of projections are formed on the surface on the dielectric body side of the electrically-conductive elastic body. In this case, when a load is applied to the sensor part A, the projections come into contact with the dielectric body, and the number of the projections in contact with the dielectric body increases. After having come into contact with the dielectric body, the projections contract in accordance with increase in the load. Accordingly, the contact area between the projections and the dielectric body increases and the capacitance between the electrode and the electrically-conductive elastic body changes. Then, based on change in the capacitance, the load is detected. In this case as well, due to the provision of the buffer part 30 between adjacent two sensor parts A, false detection of a load in the sensor part A where no load is applied can be suppressed.

In addition to the above, various modifications can be made as appropriate to the embodiments of the present invention without departing from the scope of the technical idea defined by the claims.

What is claimed is:

1. A load sensor configured to detect, as change in capacitance, change, in a contact area between an electrically-conductive elastic body and a dielectric body, that occurs due to a load applied to an upper face of the load sensor, wherein
a plurality of sensor parts each configured to detect the load are disposed so as to be arranged in a plane direction, and
a buffer part configured to suppress displacement of the upper face due to the load applied to a first sensor part from being propagated to a second sensor part adjacent to the first sensor part is disposed between the first sensor part and the second sensor part.

2. The load sensor according to claim 1, comprising
a sheet-shaped member forming the upper face, wherein
rigidity of the sheet-shaped member in the buffer part is lower than rigidity of the sheet-shaped member in the sensor part.

3. The load sensor according to claim 2, wherein
a cross-sectional shape of the buffer part is different from a cross-sectional shape of the sheet-shaped member in the sensor part.

4. The load sensor according to claim 3, wherein
a thickness of the sheet-shaped member in the buffer part is smaller than a thickness of the sheet-shaped member in the sensor part.

5. The load sensor according to claim 3, wherein
the buffer part has a shape in which at least a part of the sheet-shaped member is cut off.

6. The load sensor according to claim 2, wherein
an elastic modulus of the sheet-shaped member in the buffer part is smaller than an elastic modulus of the sheet-shaped member in the sensor part.

7. The load sensor according to claim 1, comprising
an electrically-conductive member having electrical conductivity and extending so as to cross a direction in which the electrically-conductive elastic body extends, wherein
the dielectric body is disposed between the electrically-conductive elastic body and the electrically-conductive member, and
the sensor part is positioned at an intersection between the electrically-conductive elastic body and the electrically-conductive member.
